(19) United States
(12) Patent Application Publication
(10) Pub. No.: US 2018/0315451 A1
(43) Pub. Date: Nov. 1, 2018

(54) METADATA PROCESSING FOR AN OPTICAL MEDIUM

(71) Applicant: INTERNATIONAL BUSINESS MACHINES CORPORATION, ARMONK, NY (US)

(72) Inventor: Rajamohan GANDHASRI, San Jose, CA (US)

(21) Appl. No.: 15/497,710

(22) Filed: Apr. 26, 2017

(51) Int. Cl. G11B 20/00; G11B 7/0055; G06F 12/14

(52) U.S. Cl. CPC G11B 20/00224; G06F 2212/402; G06F 12/1408; G11B 7/0055

(57) ABSTRACT

A system may include a key management server configured to store encryption keys. The system may also include a storage device that includes a processor, a memory coupled to the processor, and an optical medium coupled to the processor. The processor may be configured to encrypt and write data to the optical medium based upon the encryption keys, the data having metadata associated therewith, store the metadata in the memory, and read selected encrypted data from the optical medium. The processor may also be configured to retrieve the metadata associated with the selected encrypted data, retrieve a respective encryption key based upon the retrieved metadata, and decrypt the selected encrypted data based upon the respective encryption key. The processor may further be configured to delete selected metadata from the memory in response to a delete instruction so that the respective data is unreadable.

### BACKGROUND

The present invention relates to optical media, and more specifically, to encryption of data on optical media. An optical medium may permit the storage of data on an optically readable medium. For example, data may be recorded by patterning based upon laser light on an optical disc. Of course, there are other forms of optical media that may not rely on a laser for reading and/or writing.

An optical medium, for example, an optical disc, may be in the form of a write-once optical storage medium. A write-once optical storage medium generally does not permit data stored on the optical medium to be changed once written. Thus, upon a deletion of data, data may remain physically on the optical medium.

### SUMMARY

A system may include a key management server configured to store a plurality of encryption keys. The system may also include a storage device that includes a processor, a memory coupled to the processor, and at least one optical medium coupled to the processor. The processor may be configured to encrypt and write data to the at least one optical medium based upon the plurality of encryption keys, the data having metadata associated therewith, store the metadata in the memory, and read selected encrypted data from the at least one optical medium. The processor may also be configured to retrieve the metadata associated with the selected encrypted data, retrieve a respective encryption key based upon the retrieved metadata, and decrypt the selected encrypted data based upon the respective encryption key. The processor may further be configured to delete selected metadata from the memory in response to a delete instruction so that the respective data is unreadable.

The metadata may include an encryption key identifier. The at least one optical medium may include a write-once optical medium, for example.

The at least one optical medium may include an array of optical media. The data may include object data, for example.

The key management server may be remote from the storage device, for example. The metadata may include at least one of a name of the data, a size of the data, and a hashing algorithm.

A computer-implemented method aspect may include using a processor to encrypt and write data to at least one optical medium coupled to the processor based upon a plurality of encryption keys stored on a key management server, the data having metadata associated therewith, and store the metadata in a memory coupled to the processor. The processor may also be used to read selected encrypted data from the at least one optical medium, retrieve the metadata associated with the selected encrypted data, and retrieve a respective encryption key based upon the retrieved metadata. The processor may further be used to decrypt the selected encrypted data based upon the respective encryption key, and delete selected metadata from the memory in response to a delete instruction so that the respective data is unreadable.

A computer-readable medium aspect is directed to a computer-readable medium that includes computer executable instructions that when executed by a processor cause the processor to perform operations that may include encrypting and writing data to the at least one optical medium based upon a plurality of encryption keys stored on a key management server, the data having metadata associated therewith, and storing the metadata in the memory. The operations may also include reading selected encrypted data from the at least one optical medium, retrieving the metadata associated with the selected encrypted data, and retrieving a respective encryption key based upon the retrieved metadata. The operations may further include decrypting the selected encrypted data based upon the respective encryption key, and deleting selected metadata from the memory in response to a delete instruction so that the respective data is unreadable.

### BRIEF DESCRIPTION OF THE DRAWINGS

FIG. 1 is a schematic block diagram of a system according to an embodiment.

FIG. 2 is a schematic block diagram of a portion of a system according to another embodiment.

FIG. 3 is a flow chart illustrating a method according to an embodiment.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

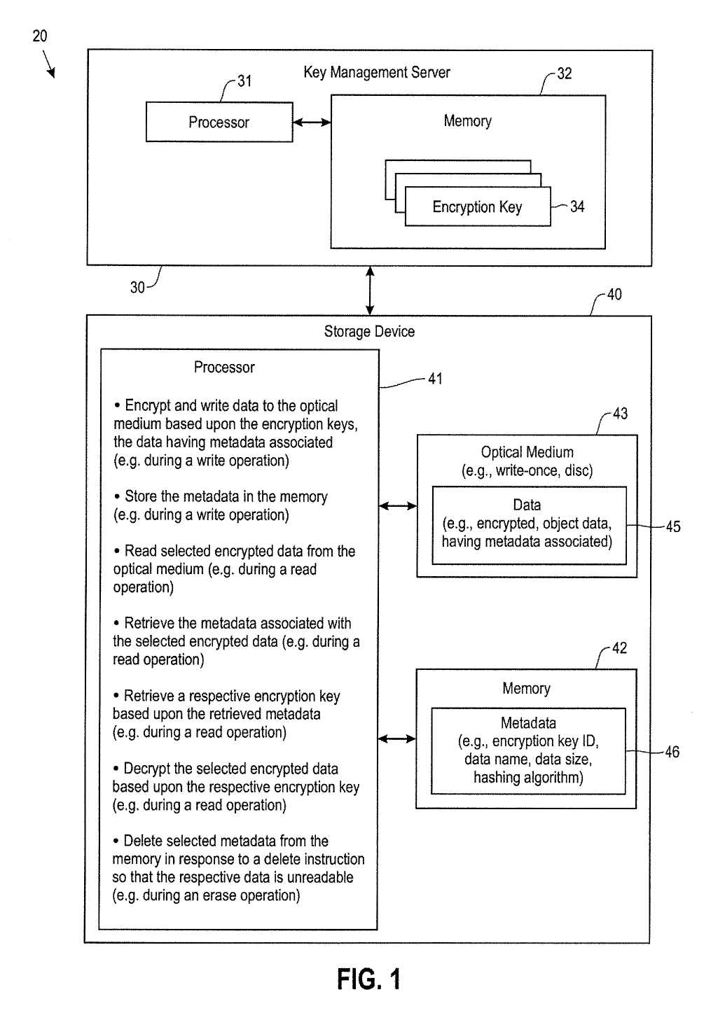

Referring initially to FIG. 1, a system 20 illustratively includes a key management server 30 configured to store encryption keys 34. More particularly, the key management server 30 includes a processor 31 and a memory 32 coupled to the processor for storing the encryption keys 34. The memory 32 may be in the form of a hard disk drive and/or solid state drive (e.g., a flash drive). Of course, the memory 32 may be another form or type of memory. Access to the key management server 30 may be protected, for example, by way of a password.

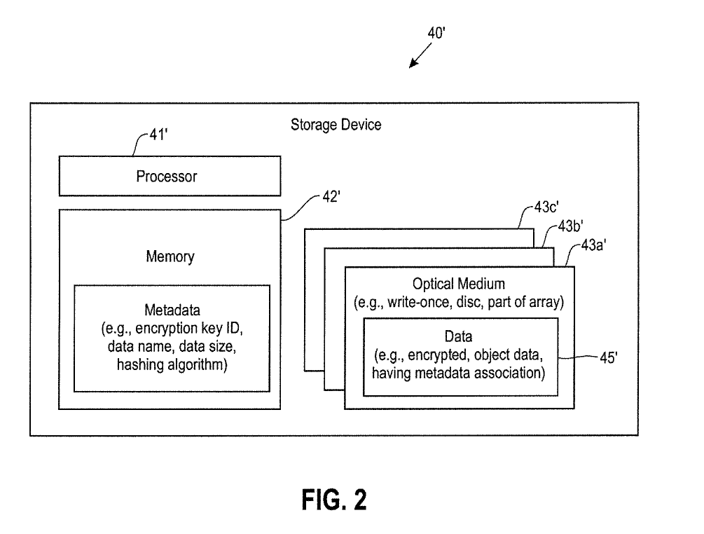

The system 20 also includes a storage device 40 that includes a processor 41, a memory 42 coupled to the processor. The storage device 40 may be remote from the key management server 30, for example. The memory 42 may be in the form of a hard disk drive and/or solid state drive (e.g., a flash drive). Of course, the memory 42 may be another form or type of memory. An optical medium 43 is coupled to the processor 41. The optical medium 43 may include an optical disc, for example. The optical medium 43 may be another type of optical medium, as will be appreciated by those skilled in the art. The optical medium 43 may be a write-once optical medium, for example. Referring briefly to FIG. 2, in some embodiments, there may be more than one optical medium, for example, an array of optical media 43a′-43c′. Other configurations and/or types of optical media 43 may be used.

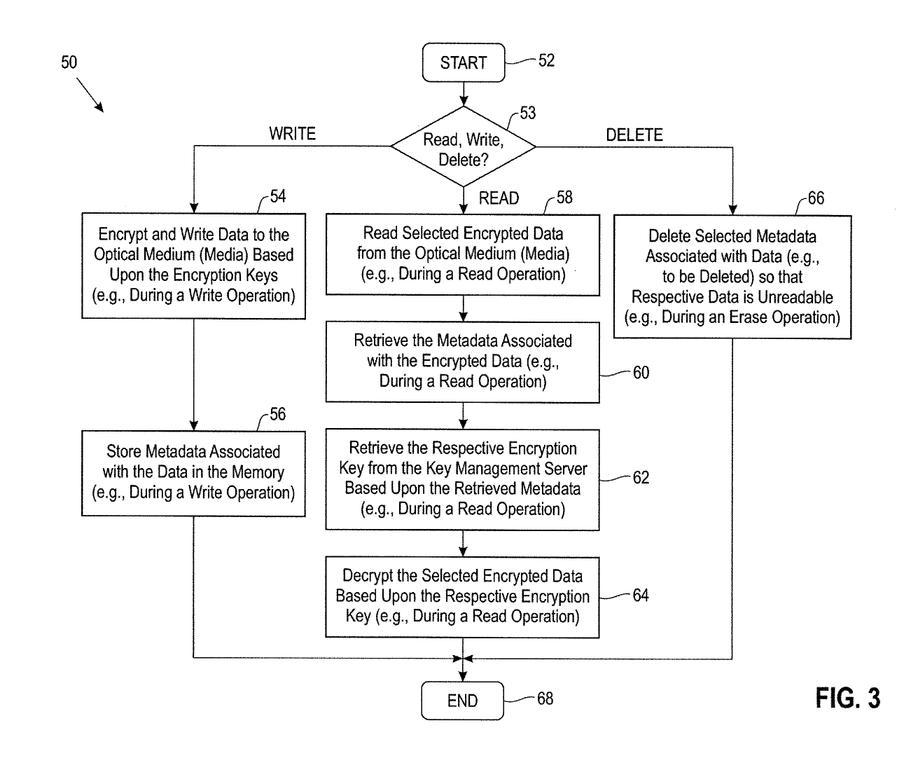

Referring now additionally to the flowchart 50 in FIG. 3, beginning at Block 52, for example, during a write-operation, determined at Block 53, the processor 41 encrypts and writes data 45, for example, object data to the optical medium 43 based upon the encryption keys 34 (Block 54). The data 45 has metadata 46 associated therewith. For example, the metadata 46 may include any of an encryption key identifier, a name of the data, a size of the data, and a hashing algorithm (e.g., MD5 hash, and/or for use in generating a unique identifier). Of course, the metadata 46 may include other and/or additional elements or items. At Block 56, the metadata 46 is stored in the memory 42.

During a read-operation (Block 53), for example, at Block 58, selected encrypted data 45 is read from the optical medium 43. At Block 60, the metadata 46 associated with the selected encrypted data is retrieved, for example, from the memory 42. To be able to read the retrieved encrypted data 45, the data is to be decrypted. Accordingly, at Block 62, a respective encryption key 34 is retrieved from the key management server 30, and more particularly, the memory 32 of the key management server, based upon the retrieved metadata. At Block 64, the selected encrypted data 45 is decrypted based upon the respective encryption key 34.

During a delete-operation (Block 53), selected metadata 46 is deleted from the memory 42 in response to a delete instruction, for example, from a client, so that the respective data is unreadable (Block 66). The method ends at Block 68.

As will be appreciated by those skilled in the art, data and/or data object stored on a write-once optical medium may be vulnerable to be compromised if the optical medium is, for example, stolen. Additionally, when a data object is deleted, generally only a reference to the location information of the data object on the optical medium is deleted from the metadata associated with the object data, however, the object data continues to exist on the optical medium. When a data object is deleted, the optical medium, for example, in the form of an optical disc, typically cannot be ejected and destroyed, as the disc contains other valid data objects. Waiting for all the data objects to be deleted from the disc before it can be destroyed may could a relatively long time, but still the deleted data objects exist intact on the disc.

The system 20 addresses this by obtaining an encryption key 34 from the key management server 30, and using the encryption key to encrypt the data or object data 45. Hence, the data may be securely stored on the optical medium 43. When object is deleted, or expired, the corresponding encryption key 34 is thus deleted from the metadata 46, thus rendering the object data 45 indecipherable. Thus, the system 20 provides a secure key per object approach and addresses life cycle management of data objects 45 stored on write-once optical medium 43.

A computer-implemented method aspect includes using a processor 41 to encrypt and write data 45 to at least one optical medium 43 coupled to the processor based upon encryption keys 34 stored on a key management server 30. The data 45 has metadata 46 associated therewith. The processor 41 is used to store the metadata 46 in a memory 42 coupled to the processor. The processor may also be used to read selected encrypted data 45 from the at least one optical medium 43, retrieve the metadata 46 associated with the selected encrypted data 45, and retrieve a respective encryption key 34 based upon the retrieved metadata. The processor 41 may further be used to decrypt the selected encrypted data 45 based upon the respective encryption key 34, and delete selected metadata 46 from the memory 42 in response to a delete instruction so that the respective data is unreadable.

A computer-readable medium aspect is directed to a computer-readable medium that includes computer executable instructions that when executed by a processor 41 cause the processor to perform operations that may include encrypting and writing data 45 to the at least one optical medium 43 based upon encryption keys 34 stored on a key management server 30. The data 45 having metadata 46 associated therewith. The operations also include storing the metadata 46 in the memory 42, reading selected encrypted data 45 from the at least one optical medium 43, retrieving the metadata associated with the selected encrypted data, and retrieving a respective encryption key 34 based upon the retrieved metadata. The operations further include decrypting the selected encrypted data 45 based upon the respective encryption key 34, and deleting selected metadata 46 from the memory 42 in response to a delete instruction so that the respective data is unreadable.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission medium (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a key management server configured to store a plurality of encryption keys; and
a storage device comprising a processor, a memory coupled to the processor, and at least one optical medium coupled to the processor, the processor configured to
encrypt and write data to the at least one optical medium based upon the plurality of encryption keys, the data having metadata associated therewith,
store the metadata in the memory,
read selected encrypted data from the at least one optical medium,
retrieve the metadata associated with the selected encrypted data,
retrieve a respective encryption key based upon the retrieved metadata,
decrypt the selected encrypted data based upon the respective encryption key, and
delete selected metadata from the memory in response to a delete instruction so that the respective data is unreadable.

2. The system of claim 1 wherein the metadata comprises an encryption key identifier.

3. The system of claim 1 wherein the at least one optical medium comprises a write-once optical medium.

4. The system of claim 1 wherein the at least one optical medium comprises an array of optical media.

5. The system of claim 1 wherein the data comprises object data.

6. The system of claim 1 wherein the key management server is remote from the storage device.

7. The system of claim 1 wherein the metadata comprises at least one of a name of the data, a size of the data, and a hashing algorithm.

8. A storage device comprising:
a processor;
a memory coupled to the processor; and
at least one optical medium coupled to the processor;
the processor configured to
encrypt and write data to the at least one optical medium based upon a plurality of encryption keys stored on a key management server, the data having metadata associated therewith,
store the metadata in the memory,
read selected encrypted data from the at least one optical medium,
retrieve the metadata associated with the selected encrypted data,
retrieve a respective encryption key based upon the retrieved metadata,
decrypt the selected encrypted data based upon the respective encryption key, and
delete selected metadata from the memory in response to a delete instruction so that the respective data is unreadable.

9. The storage device of claim 8 wherein the metadata comprises an encryption key identifier.

10. The storage device of claim 8 wherein the at least one optical medium comprises a write-once optical medium.

11. The storage device of claim 8 wherein the at least one optical medium comprises an array of optical media.

12. The storage device of claim 8 wherein the data comprises object data.

13. A computer-implemented method comprising:
using a processor to
encrypt and write data to at least one optical medium coupled to the processor based upon a plurality of encryption keys stored on a key management server, the data having metadata associated therewith,
store the metadata in a memory coupled to the processor,
read selected encrypted data from the at least one optical medium,
retrieve the metadata associated with the selected encrypted data,
retrieve a respective encryption key based upon the retrieved metadata,
decrypt the selected encrypted data based upon the respective encryption key, and
delete selected metadata from the memory in response to a delete instruction so that the respective data is unreadable.

14. The computer-implemented method of claim 13 wherein the metadata comprises an encryption key identifier.

15. The computer-implemented method of claim 13 wherein the at least one optical medium comprises a write-once optical medium.

16. The computer-implemented method of claim 13 wherein the at least one optical medium comprises an array of optical media.

17. A computer-readable medium comprising computer executable instructions that when executed by a processor cause the processor to perform operations comprising:
encrypting and writing data to the at least one optical medium based upon a plurality of encryption keys stored on a key management server, the data having metadata associated therewith,
storing the metadata in the memory,
reading selected encrypted data from the at least one optical medium,
retrieving the metadata associated with the selected encrypted data,
retrieving a respective encryption key based upon the retrieved metadata,
decrypting the selected encrypted data based upon the respective encryption key, and
deleting selected metadata from the memory in response to a delete instruction so that the respective data is unreadable.

18. The computer-readable medium of claim 17 wherein the metadata comprises an encryption key identifier.

19. The computer-readable medium of claim 17 wherein the at least one optical medium comprises a write-once optical medium.

20. The computer-readable medium of claim 17 wherein the at least one optical medium comprises an array of optical media.
